(19) United States
(12) Patent Application Publication
(10) Pub. No.: US 2014/0143184 A1
(43) Pub. Date: May 22, 2014

(54) TURN RESTRICTION INFERENCING

(71) Applicant: MICROSOFT CORPORATION, Redmond, WA (US)

(72) Inventors: Emmanouil Koukoumidis, Bellevue, WA (US); Brian Beckman, Newcastle, WA (US)

(73) Assignee: MICROSOFT CORPORATION, Redmond (WA)

(21) Appl. No.: 13/683,857

(22) Filed: Nov. 21, 2012

(51) Int. Cl. G06N 5/04; G06N 99/00

(52) U.S. Cl. CPC G06N 5/04; G06N 99/005
USPC 706/12; 706/52

(57) ABSTRACT

Architecture that extracts turn restrictions from geolocation traces both offline and online (in realtime). By identifying from the location traces which specific turns a driver takes and at which points in time, turn restrictions and associated time-dependence can be mined (inferred). Turn restrictions can be inferred based on the nature of drivers who tend to take the shortest route. The architecture can infer allowed turns and turn restrictions by mining user location traces, infer turn restrictions and associated confidence scores by comparing the routes followed by users with the routes that are shortest when applying the set of known turn restrictions, and infer turn restrictions based on the accessibility criterion such as each road section (between two adjacent intersections) is accessible in at least one way. A scoring method is provided for calculating the probability for a turn restriction to exist by fusing the scores described above with statistical information.

### BACKGROUND

Existing maps contain a significant amount of erroneous and out-of-date turn restrictions information about which turns are allowed and which turns are not allowed (referred to as turn restrictions). For example, some turns are not allowed at all, and other turns are allowed only for specific types of vehicles. Incorrect turn restriction information can result in calculating incorrect routes, and therefore, a poor user experience (e.g., driver frustration, accidents, etc.). Turn restrictions may also change over time when decisions are made to change the structure of the road network such as turning a two-way road into a one-way road or closing a road temporarily because of road work. Thus, it is a challenge to maintain the latest turn restriction information.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture extracts turn restrictions (collectively as allowed turns and non-allowed turns) from location traces (e.g., global positioning system (GPS)) both offline and online (in realtime). By identifying from the location traces which specific turns a driver takes and at which points in time, turn restrictions and associated time-dependence can be mined (inferred).

Turn restrictions can be inferred based on the nature of drivers who tend to take the shortest route. When heading from point A to point B, if a driver does not take what seems to be the shortest “allowed” route R₁, but a longer route R₂, then it can be inferred that the currently allowed route R₁ is not allowed because of a turn restriction of which the architecture is unaware. Subsequently, it can be inferred that one of the turns along route R₁ is not allowed, and then associate a confidence score with this turn restriction.

The architecture can infer allowed turns and non-allowed turns by mining user location traces, infer turn restrictions and associated confidence scores by comparing the routes followed by users with the routes that are shortest when applying the set of known turn restrictions, and infer turn restrictions based on the accessibility criterion such as each road section (between two adjacent intersections) is accessible in at least one way.

A scoring method is provided for calculating the probability for a turn restriction to exist by combining the scores described above with statistical information (e.g., left turns are allowed, on average, in a percentage (e.g., 60%) of the intersections, one-way streets usually have opposite direction when compared to neighboring parallel one-way streets, smaller streets or dead-ends are used less often etc.). Additionally, optimization methods can be applied that integrate any of the methods and rules described above to attain the most likely set of viable turn restrictions. The use of any of the above as features can be utilized to train machine learning algorithms for the purpose of classifying turn restrictions (e.g., classifying a turn as allowed or disallowed).

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates an exemplary diagram of turn restriction computing in association with the disclosed architecture.

FIG. 3 illustrates a feature set of possible features that can be utilized by the inference component to compute a turn restriction.

FIG. 4 illustrates a method in accordance with the disclosed architecture.

FIG. 5 illustrates an alternative method in accordance with the disclosed architecture.

FIG. 6 illustrates a block diagram of a computing system that executes turn restriction inference computation in accordance with the disclosed architecture.

### DETAILED DESCRIPTION

The disclosed architecture extracts turn restrictions (allowed turns and non-allowed turns) from geolocation information (e.g., global positioning system (GPS)) traces (one or more geographical coordinates) both offline and online (in realtime). By identifying from the location traces which specific turns drivers take and do not take, and optionally, at which points in time (time-dependence data), turn restrictions can be inferred. Moreover, turn restrictions can be inferred based on an assumption that drivers tend to take the shortest route (path or route) to a destination. When heading from point A to point B, if drivers do not take what seems to be the shortest “allowed” route R₁, but a longer route R₂, then it can be inferred that route R₁ is not allowed most likely because of some unknown restriction (e.g., road construction, weather conditions, accident, etc.). Subsequently, an inference can be made that one of the turns along route R₁ is not allowed and a confidence score can be associated with this turn restriction.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

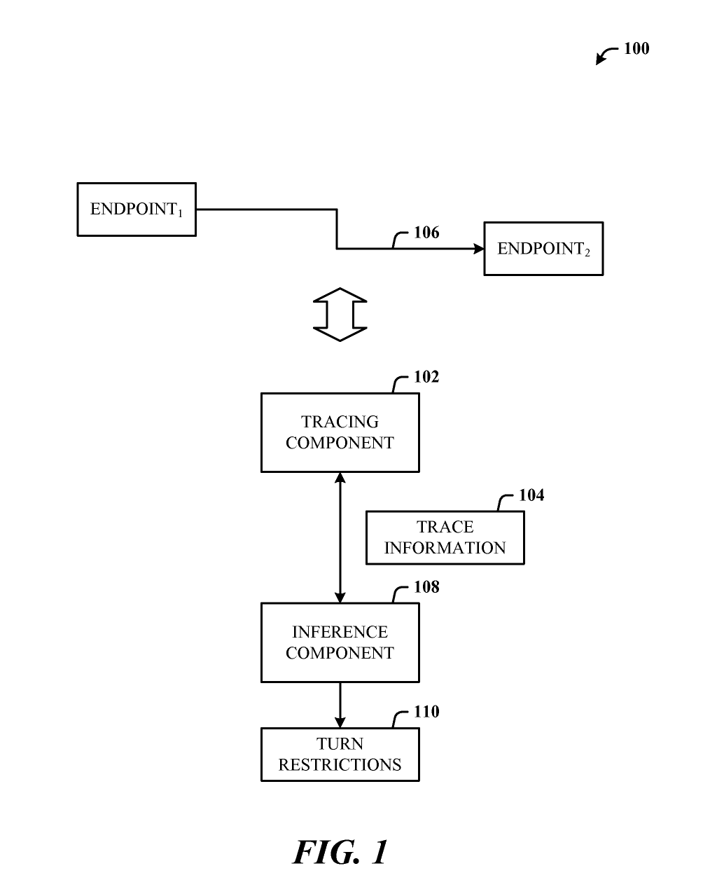

FIG. 1 illustrates a system 100 in accordance with the disclosed architecture. The system 100 can include a tracing component 102 that provides trace information 104 of user travel on a geographical path 106 between geographical endpoints (Endpoint₁ and Endpoint₂). An inference component 108 infers turn restrictions 110 (allowed and non-allowed turns) along the geographical path 106 based on the trace information 104.

The inference component 108 infers the turn restrictions 110 based on time dependencies of one or more of the turn restrictions 110. The inference component 108 associates a confidence score with a turn restriction for a turn that is not allowed. The inference component 108 infers the turn restrictions 110 based on a comparison of paths followed by travelers with shortest paths when applying a set of known turn restrictions associated with the path 106. The inference component 108 infers the turn restrictions 110 based on accessibility criteria related to road (or path) sections. For example, the path can be segmented by blocks so that turns can be allowed/not allowed on a block-by-block basis. In a more granular implementation, path segments can also include alleys, driveways, on-ramps, exit ramps, and so on.

The inference component 108 computes a probability of a turn restriction based on probability scores and statistical information. The inference component 108 makes inferences based on features that are used to train a machine learning algorithm. The features include, but are not limited to, parameters described herein such as time-dependencies, geographical location (e.g., residential area, neighborhood, industrial area, downtown, suburb, major highway or street, hospitals nearby, fire stations, police stations, etc.), type of turn (e.g., left, right, merge, etc.), type of street (one-way, two-way, etc.), weather conditions, user identity of who is driving (and thus, user stop and turn preferences on that path), road conditions (e.g., construction, constricted traffic flow--single lane over a bridge, etc.), and so on.

The inference component 108 makes an inference as to a turn restriction based on an aggregation of statistics of other user travel (of one or more users) along a (first) path that includes either or both of the geographical endpoints. In other words, there may be a second path that can be taken between the endpoints such that turn restrictions on the first path can be computed based on one or more turn restrictions on the parallel or second path, or third path, etc.

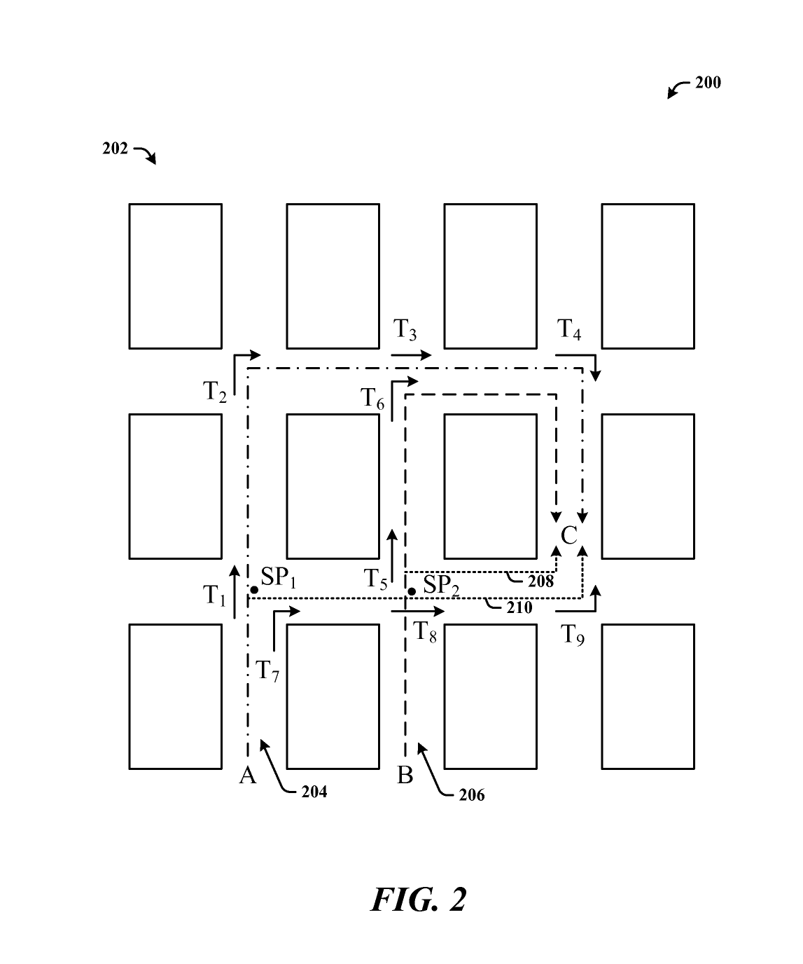

FIG. 2 illustrates an exemplary diagram 200 of turn restriction computing in association with the disclosed architecture. User location traces via commonly known technologies such as GPS, triangulation, etc., can be used to extract the turn restrictions. Based on an initial assumption that there is no prior information about turn restrictions in an area 202, and that all turns are allowed, consider the following scenario. From received user location traces, users travelling from point A to point C take a route 204 (also called a path, and denoted by a dashed-dot line pattern), whereas users travelling from point B to point C a route 206 (also called a path, and denoted purely by a dashed line).

From the user location traces it can be inferred with a specific confidence/score (depending on the statistics of the users taking the specific routes) that certain turns are allowed. (Note that as defined herein a “turn” not only includes changing direction such as turning left or turning right, as commonly understood, but also includes travelling straight, as in through an intersection. Thus, T₁ is also called a turn.) For example, from the route 204 that users follow it can be inferred that turn T₁, turn T₂, turn T₃, and turn T₄ are allowed turns. Based on the route 206, it can be inferred similarly that turns T₅, T₆, and T₄ are also allowed turns taken to point C. Since turn T₄ appears in both routes (204 and 206), it can be inferred with a higher degree of confidence (higher statistics) that turn T₄ is an allowed turn.

Additionally, trace information indicating that routes 208 and 210 were not used by any user or not used but by a very small number of users, as for turn T₉, for example, creates some degree of confidence that turn T₉ is likely a non-allowed turn. The confidence score can depend on the fraction and/or an absolute number of users that went through intersections and did or did not take turn T₉, and the street segment to which turn T₉ ultimately leads. If, for example, turn T₉ leads to a small dead-end alley, then it can be expected that only a tiny fraction of users (if any) will take turn T₉ despite that it is an allowed turn.

More features can be used as well. For example, if the road conditions of a specific road segment (e.g., segment SP₁-SP₂, defined by segment points SP₁ and SP₂ as approximately centers of intersections) are very poor (e.g., potholes, roadwork, etc.) then it can be expected that users will generally try to avoid this road segment and the turns (turn T₇ and turn T₈) that lead to it.

Turn restrictions can be inferred based on the notion that users tend to take the shortest route to a destination. Whenever users do not take what appears to be the shortest route (path), this is most likely because of one or more turn restrictions of which the architecture is unaware. For example, consider that users take the route 204 from point A to point C. However, if all turns were allowed (assuming zero prior knowledge about non-allowed turns), then from point A to the dotted line of route 210 (defined by turns T₇, T₈, and T₉) would be the shortest route to point C.

Since route 204 departs from route 210 (the routes do not coincide), this gives a hint that some turn restrictions exist along route 210. The case of route 210 (defined by turns T₇, T₈, and T₉) departing from route 204, and being a shorter route than the route 204 (defined by turns T₁, T₂, T₃, and T₄), indicates some degree of confidence that turn T₇, turn T₈, or turn T₉, or any combination thereof, is not allowed.

Similarly, route 206 (defined by turns T₅, T₆, and T₄) creates some degree of confidence that turns T₈ or T₉ are potentially not allowed, since route 206 departs from shorter route 210. The existence of both route 204 (and not route 210) and route 206 (and not 208) suggests that either (or both) of turn T₈ or (and) turn T₉ are not allowed, and further increases the confidence that turn T₈ and turn T₉ are not allowed.

Statistics aggregation may also be employed. For example, travelling into an intersection (e.g., SP₂) is commonly allowed (and rarely, not allowed). Turning right (e.g., a turn T₇) is usually allowed (and rarely not allowed), whereas turning left is not allowed a more frequently than turning right.

All the above techniques can be used to build a confidence score about whether a specific turn is allowed or not allowed. In this simple scenario, for example, turn T₉ has the highest confidence (score) of being not allowed because turn T₉ appears in the both the routes 204/210 and the routes 206/208, but turn T₉ is not taken by the users, and, turn T₉ is a left turn.

All the above rules may be combined with a search space exploration and/or optimization algorithm (e.g., genetic search that inserts and evaluates the plausibility of specific sets of turn restrictions by mutating allowed turns into non-allowed turns and non-allowed turns into allowed turns) to derive a most likely set of turn restrictions that best validates the observed user location traces and/or aggregate statistics.

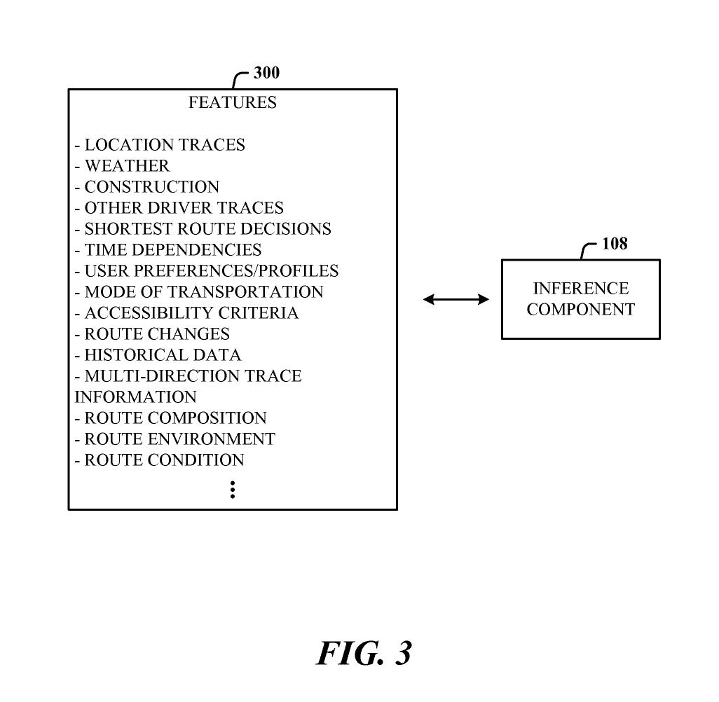

FIG. 3 illustrates a feature set 300 of possible features that can be utilized by the inference component 108 to compute a turn restriction. The set 300 can include, but is not limited to, location traces, weather, construction, other driver traces, shortest route decisions, time dependencies, user preferences/profiles, mode of transportation, accessibility criteria, route changes, historical data, multi-direction trace information, route composition, route environment, route condition, and so on.

Location traces have been described previously as that geographical information such as coordinates related to travel along a route (path). The trace information can be obtained from mobile devices such as cell phones, tablets, and other suitable devices. The location trace can include a single segment of multiple segments of the overall route traveled between at least two endpoints. The segment can be physically defined according to structures such as buildings and streets, for example. A commonly characterized segment can be a city block that includes major streets and avenues such that the segment of the route travelled extends between two consecutive streets or two consecutive avenues. The traces can be obtained according to suitable time frequencies such as every second, for example.

The weather can be employed as a feature. For example, weather information can be obtained from weather websites that provide weather data for the route travelled and the endpoints. The state of the weather can impact if the trace will include a dirt road versus a more main (or paved) road. If the weather is rainy, it is more likely that most users will avoid the dirt road. However, the fact that most users avoided the dirt road does not mean that there is an actual turn restriction. In other words, even if very few users turn onto the dirt road, the architecture will still be able to successfully classify this as an allowed turn, as it is expected that very few users will use this road under such weather conditions.

With respect to other driver (traveler) traces, this data can be used to establish the turn restrictions for a given period of time. For example, if other traveler traces indicate the absence of turns at a specific junction, it can be inferred that the junction is a non-allowed turn at this time. The age of this information can be tracked to age out the information over time such as every two weeks, since it can be determined on average that street construction may typically not last longer, and hence, such trace data would be unimportant after the street is ready for travel.

The routes established by others in response to a non-allowed turn can also be useful in anticipating the route should a similar condition exist for that non-allowed turn or another restricted turn in the area or of that segment.

The shortest (shorter)-route decision was previously described briefly. This feature can be based on knowledge of travelers, instructions posted on the route (e.g., detour), and learned information. The shortest route can be known or learned based on any number of factors. Thus, the generated turn restriction can be relative to the known and/or learned shortest (shorter) route.

The time dependencies feature facilitates inferring a turn restriction based on times when travel may be elevated, or not elevated such as rush hour (elevated for downtown and major arteries), holidays (not elevated downtown unless an event is scheduled), weekends (not elevated for downtown), etc.

User preferences and user profiles can also be employed as features that impact the identification of a turn restriction as allowed or non-allowed. For example, if it known that a given user prefers to travel a certain route (as defined by repeated location traces) between endpoints, this information can be used to infer or at least provide some weight that a turn restriction is non-allowed if the user varies from the preferred path. If the user profile indicates the user drives an expensive car, this can be some piece of information which may indicate that the user will take a main well-traveled route rather than a shorter route through is less secure. If the user profile indicates the user usually take public transportation, this information can indicate validation of a non-allowed turn.

The mode of transportation (or mode of travel) feature can indicate how a given user travels, by foot, public transportation, carpool, personal vehicle, two-wheeled vehicle, and so on. This can be included as metadata with the location trace. If the user travels on foot, this data may be less useful since it is unlikely that any turn restriction would be useful to others who are driving, for example. The mode of travel becomes more useful to another user using the same type of travel.

The accessibility criteria follow closely with some of the other features, such as construction, weather, and so on.

Route changes can occur frequently for any number of reasons, mainly due to construction and associated detours, and weather. Rush hour may impact a route change by routinely changing a 5-lane highway into a 2-lane highway only during rush hour to improve traffic flow out of the city. Based on time, the route will then be changed back after rush hour ends. Thus, a turn restriction can be inferred based on the route change. If based also on a time dependency, more frequent trace updates can be employed to monitor the restriction.

Historical data can be mined over any time periods and routes to make inferred turn restrictions on any one or more of the disclosed features.

Multi-direction trace information can be processed to not only consider trace data from point A to point B, but also from point B to point A. It is likely that the same turn restrictions will be in force regardless of the direction along the same route.

A route composition feature comprises all the streets, avenues, dirt roads, highways, etc., that may be part of a given route between endpoints. Each one or a combination of these parts can be used to infer if a turn restriction occurs at any point along the route. A route environment feature described if the route or segments thereof pass through residential areas, industrial areas, school zones, major highways, countryside, and so on. The route condition feature indicates the condition of the route at any given point or segment along the route, such as a bridge is out, road construction, flooded, and so on. This can also overlap with or be closely related to the accessibility feature. Other features can be defined and employed as desired to improve the inference of the turn restriction(s) of a route (path). Moreover, probability scores can be computed and applied for each turn restriction determined according to one or more of the features described herein.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

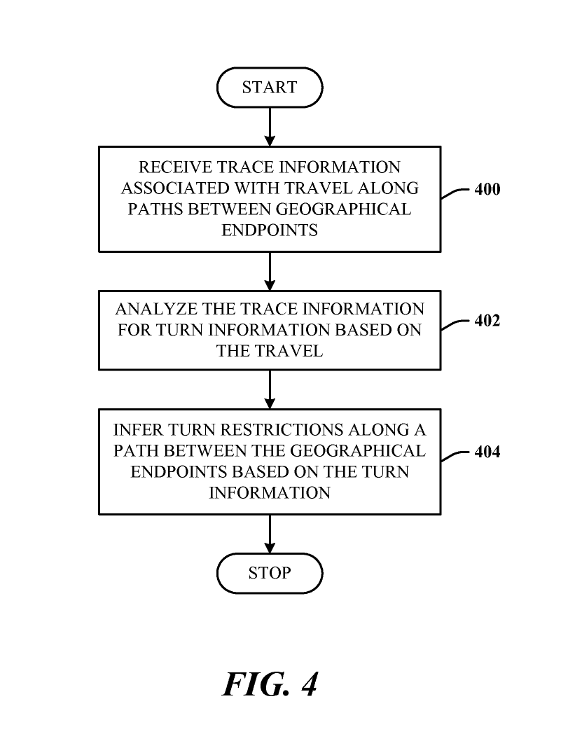

FIG. 4 illustrates a method in accordance with the disclosed architecture. At 400, trace information associated with travel along paths between geographical endpoints, is received. At 402, the trace information is analyzed for turn information based on the travel. At 404, turn restrictions along a path between the geographical endpoints are inferred based on the turn information.

The method can further comprise inferring time dependencies of the turn restrictions along the path, and inferring the turn restrictions based on driver tendencies. The method can further comprise assigning a confidence score to a turn restriction along the path. The method can further comprise inferring the turn restrictions based on accessibility criteria to the path, and inferring the turn restrictions based on a probability computation of turn scores and statistical information of known path turns. The method can further comprise training a machine learning algorithm to automatically classify a turn as allowed or not allowed.

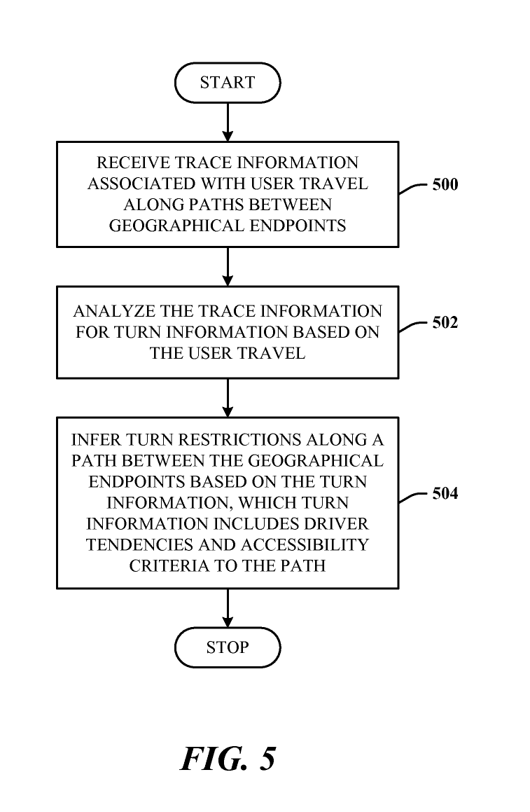

FIG. 5 illustrates an alternative method in accordance with the disclosed architecture. At 500, trace information associated with user travel along paths between geographical endpoints is received. At 502, the trace information is analyzed for turn information based on the user travel. At 504, turn restrictions along a path between the geographical endpoints are inferred based on the turn information, which turn information includes driver tendencies and accessibility criteria to the path.

The method can further comprise assigning a confidence score to a turn restriction along the path. The can further comprise inferring the turn restrictions based on a probability computation of turn scores and statistical information of known path turns. The method can further comprise training a machine learning algorithm to automatically classify a turn as allowed or not allowed. The method can further comprise extracting the turn restrictions online and offline in realtime.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

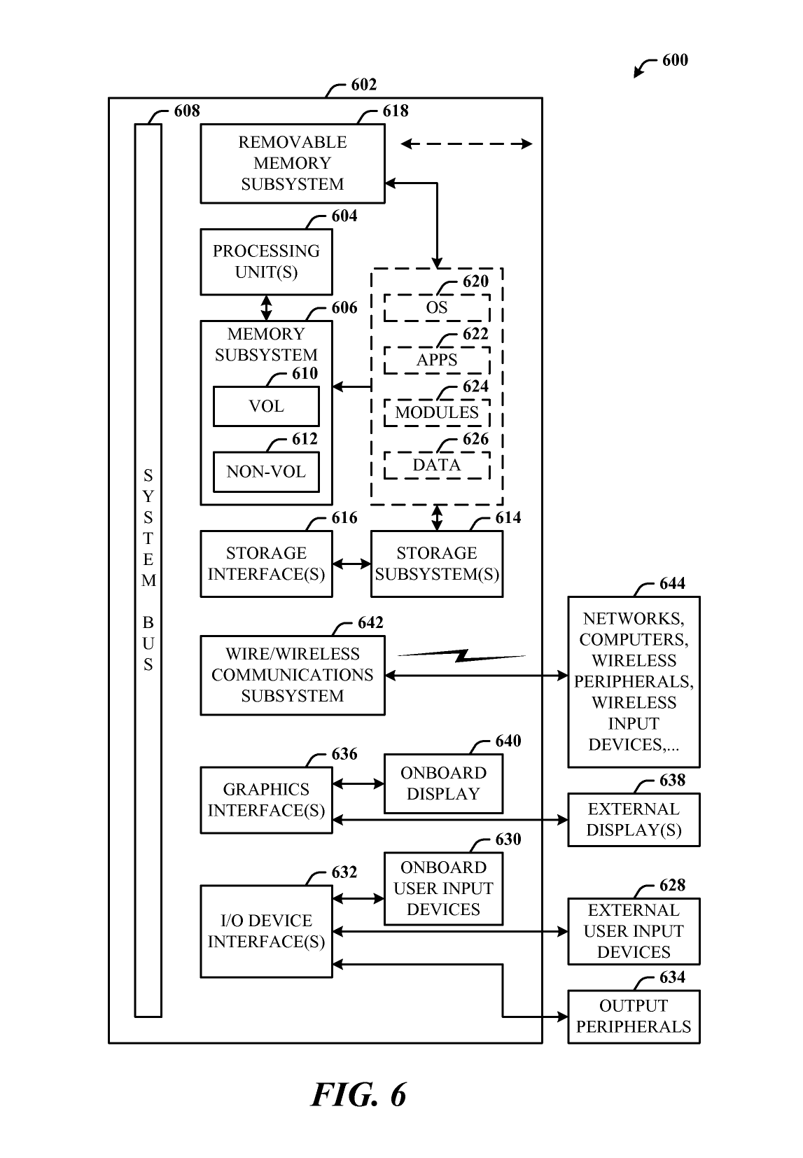

Referring now to FIG. 6, there is illustrated a block diagram of a computing system 600 that executes turn restriction inference computation in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 6 and the following description are intended to provide a brief, general description of the suitable computing system 600 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 600 for implementing various aspects includes the computer 602 having processing unit(s) 604 (also referred to as microprocessor(s) and processor(s)), a computer-readable storage such as a system memory 606, and a system bus 608. The processing unit(s) 604 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 602 can be one of several computers employed in a datacenter and/or computing resources (hardware and/or software) in support of cloud computing services for portable and/or mobile computing systems such as cellular telephones and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 606 can include computer-readable storage (physical storage media) such as a volatile (VOL) memory 610 (e.g., random access memory (RAM)) and non-volatile memory (NON-VOL) 612 (e.g., ROM, EPROM, EEPROM, etc.). A basic input/output system (BIOS) can be stored in the non-volatile memory 612, and includes the basic routines that facilitate the communication of data and signals between components within the computer 602, such as during startup. The volatile memory 610 can also include a high-speed RAM such as static RAM for caching data.

The system bus 608 provides an interface for system components including, but not limited to, the system memory 606 to the processing unit(s) 604. The system bus 608 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 602 further includes machine readable storage subsystem(s) 614 and storage interface(s) 616 for interfacing the storage subsystem(s) 614 to the system bus 608 and other desired computer components. The storage subsystem(s) 614 (physical storage media) can include one or more of a hard disk drive (HDD), a magnetic floppy disk drive (FDD), solid state drive (SSD), and/or optical disk storage drive (e.g., a CD-ROM drive DVD drive), for example. The storage interface(s) 616 can include interface technologies such as EIDE, ATA, SATA, and IEEE 1394, for example.

One or more programs and data can be stored in the memory subsystem 606, a machine readable and removable memory subsystem 618 (e.g., flash drive form factor technology), and/or the storage subsystem(s) 614 (e.g., optical, magnetic, solid state), including an operating system 620, one or more application programs 622, other program modules 624, and program data 626.

The operating system 620, one or more application programs 622, other program modules 624, and/or program data 626 can include entities and components of the system 100 of FIG. 1, turn restriction analysis and computation as shown in the diagram 200 of FIG. 2, the set 300 of features of FIG. 3, and the methods represented by the flowcharts of FIGS. 4 and 5, for example.

Generally, programs include routines, methods, data structures, other software components, etc., that perform particular tasks or implement particular abstract data types. All or portions of the operating system 620, applications 622, modules 624, and/or data 626 can also be cached in memory such as the volatile memory 610, for example. It is to be appreciated that the disclosed architecture can be implemented with various commercially available operating systems or combinations of operating systems (e.g., as virtual machines).

The storage subsystem(s) 614 and memory subsystems (606 and 618) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that does not employ propagated signals, can be accessed by the computer 602, and includes volatile and non-volatile internal and/or external media that is removable or non-removable. For the computer 602, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 602, programs, and data using external user input devices 628 such as a keyboard and a mouse, as well as by voice commands facilitated by speech recognition. Other external user input devices 628 can include a microphone, an IR (infrared) remote control, a joystick, a game pad, camera recognition systems, a stylus pen, touch screen, gesture systems (e.g., eye movement, head movement, etc.), and/or the like. The user can interact with the computer 602, programs, and data using onboard user input devices 630 such a touchpad, microphone, keyboard, etc., where the computer 602 is a portable computer, for example.

These and other input devices are connected to the processing unit(s) 604 through input/output (I/O) device interface(s) 632 via the system bus 608, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 632 also facilitate the use of output peripherals 634 such as printers, audio devices, camera devices, and so on, such as a sound card and/or onboard audio processing capability.

One or more graphics interface(s) 636 (also commonly referred to as a graphics processing unit (GPU)) provide graphics and video signals between the computer 602 and external display(s) 638 (e.g., LCD, plasma) and/or onboard displays 640 (e.g., for portable computer). The graphics interface(s) 636 can also be manufactured as part of the computer system board.

The computer 602 can operate in a networked environment (e.g., IP-based) using logical connections via a wired/wireless communications subsystem 642 to one or more networks and/or other computers. The other computers can include workstations, servers, routers, personal computers, microprocessor-based entertainment appliances, peer devices or other common network nodes, and typically include many or all of the elements described relative to the computer 602. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 602 connects to the network via a wired/wireless communication subsystem 642 (e.g., a network interface adapter, onboard transceiver subsystem, etc.) to communicate with wired/wireless networks, wired/wireless printers, wired/wireless input devices 644, and so on. The computer 602 can include a modem or other means for establishing communications over the network. In a networked environment, programs and data relative to the computer 602 can be stored in the remote memory/storage device, as is associated with a distributed system. It will be appreciated that the network connections shown are exemplary and other means of establishing a communications link between the computers can be used.

The computer 602 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a tracing component that provides trace information of user travel on a geographical path between geographical endpoints;
an inference component that infers turn restrictions along the geographical path based on the trace information; and
a microprocessor that executes computer-executable instructions associated with at least one of the tracing component or inference component.

2. The system of claim 1, wherein the inference component infers the turn restrictions based on time dependencies of one or more of the turn restrictions.

3. The system of claim 1, wherein the inference component associates a confidence score with a turn restriction for a turn that is not allowed.

4. The system of claim 1, wherein the inference component infers the turn restrictions based on a comparison of paths followed by travelers with shortest paths when applying a set of known turn restrictions associated with the path.

5. The system of claim 1, wherein the inference component infers the turn restrictions based on accessibility criteria related to road sections.

6. The system of claim 1, wherein the inference component computes a probability of a turn restriction based on probability scores and statistical information.

7. The system of claim 1, wherein the inference component makes inferences based on features that are used to train a machine learning algorithm.

8. The system of claim 1, wherein the inference component makes an inference as to a turn restriction based on an aggregation of statistics of other user travel along a path that includes either or both of the geographical endpoints.

9. A method performed by a computer system executing machine-readable instructions, the method comprising:
receiving trace information associated with travel along paths between geographical endpoints;
analyzing the trace information for turn information based on the travel;
inferring turn restrictions along a path between the geographical endpoints based on the turn information; and
configuring a processor to perform at least one of the acts of receiving, analyzing, or inferring.

10. The method of claim 9, further comprising inferring time dependencies of the turn restrictions along the path.

11. The method of claim 9, further comprising inferring the turn restrictions based on driver tendencies.

12. The method of claim 9, further comprising assigning a confidence score to a turn restriction along the path.

13. The method of claim 9, further comprising inferring the turn restrictions based on accessibility criteria to the path.

14. The method of claim 9, further comprising inferring the turn restrictions based on a probability computation of turn scores and statistical information of known path turns.

15. The method of claim 9, further comprising training a machine learning algorithm to automatically classify a turn as allowed or not allowed.

16. A method performed by a computer system executing machine-readable instructions, the method comprising acts of:
receiving trace information associated with user travel along paths between geographical endpoints;
analyzing the trace information for turn information based on the user travel;
inferring turn restrictions along a path between the geographical endpoints based on the turn information, which turn information includes driver tendencies and accessibility criteria to the path; and
configuring a processor to perform at least one of the acts of receiving, analyzing, or inferring.

17. The method of claim 16, further comprising assigning a confidence score to a turn restriction along the path.

18. The method of claim 16, further comprising inferring the turn restrictions based on a probability computation of turn scores and statistical information of known path turns.

19. The method of claim 16, further comprising training a machine learning algorithm to automatically classify a turn as allowed or not allowed.

20. The method of claim 16, further comprising extracting the turn restrictions online and offline in realtime.
